(19) United States
(12) Patent Application Publication
(10) Pub. No.: US 2003/0096670 A1
(43) Pub. Date: May 22, 2003

(54) Differential transmission apparatus

(75) Inventor: William Gordon Hunt, Roanoke, IN (US)

Correspondence Address: Liniak, Berenato, Longacre & White, Suite 240, 6550 Rock Spring Drive, Bethesda, MD, 20817, US

(73) Assignee: SPICER TECHNOLOGY, INC

(21) Appl. No.: 09/987,965

(22) Filed: Nov. 16, 2001

(51) Int. Cl. F16H 48/20

(52) U.S. Cl. 475/86

(57) ABSTRACT

A power transmission apparatus comprises a device for transmitting power by frictional force between first and second rotary members rotated relative to each other; a device for pressing the power transmitting device in a direction of increasing frictional force; and a hydraulic fluid delivery system for driving the pressing device in the direction of increasing frictional force, whereby the fluid delivery system is driven by a drive pinion gear stem. In accordance with this invention, the need for a separate hydraulic motor and pump or drive belts is eliminated thereby reducing the complexity and size of the apparatus while providing increases reliability as compared to alternative designs. The present invention also provides a unique advantage of utilizing the axle's own lubricant, thus avoiding potential cross-contamination between a specialized hydraulic fluid and the axle lubricant.

### BACKGROUND OF THE INVENTION

1. Field of the Invention

The present invention relates to an improvement of a differential transmission apparatus such as a differential apparatus for securing smooth operability of a vehicle by controlling the difference in rotation of right and left wheels.

2. Description of Related Art

Conventionally, when a vehicle's direction is changed, as when turning along a curve, a differential apparatus provides a differential for right and left wheels to secure a smooth performance. However, if one of the wheels slips on a road surface having a small coefficient of friction, such as a snow or ice, the drive force cannot be structurally transmitted to the other wheel. To solve this problem, the differential apparatus has a differential restricting mechanism for restricting the differential, which serves to move the vehicle when one of the wheels slips, the differential being generated between the right and left wheels.

Known differential restricting mechanisms have been controlled electronically or hydraulically.

A conventional differential apparatus provided with a known hydraulically actuated differential restricting mechanism is shown in FIG. 1. In FIG. 1, a differential carrier 101 has a differential gear mechanism 102 therein, and rotatably supports a differential casing 104 of the differential gear mechanism 102 through a bearing 103. A cylindrical portion 105 is formed in the differential carrier 101. When an operating oil is supplied to the cylindrical portion 105 from a remote source, a piston 106 disposed within the cylindrical portion 105 presses, through a pressing member 107, frictional plates 108 disposed in the differential casing 104 as a differential control means. When the frictional plates 108 are pressed by the piston 106, the differential casing 104 and a side gear 109 of the differential gear mechanism 102 are integrally rotated, thereby restricting the differential between the right and left wheels.

Hydraulically-actuated differential mechanisms can develop sufficient actuating forces but require a separate motor and pump.

Existing electronically controlled differentials typically use an electromagnetic coil or electric motor to apply a variable force to a clutch pack and thereby vary the torque biasing characteristic. Since space limitations do not permit a sufficiently large coil or motor to develop the necessary force, ball screws, ramps or gears are used to mechanically amplify the available force. Due to space limitations, the system may still not fully develop the optimum desired clamping force.

A need therefore exists for a differential restricting mechanism having reduced cost, complexity and size while having increased reliability and performance.

### SUMMARY OF THE INVENTION

To solve the problems mentioned above, an object of the present invention is to provide a compact power transmission apparatus having an improved mechanical strength without greatly changing the design of the differential apparatus.

With the above object in mind, the present invention provides a differential apparatus comprising a differential casing rotatably supported by a differential carrier through bearing means, and having a differential mechanism; means for restricting the differential of the differential mechanism by, for example, frictional force, said restricting means being disposed within the differential casing; means for pressing the restricting means to control the frictional force in the differential mechanism; and drive means for actuating the pressing means, whereby the drive means includes a gerotor hydraulic pump that is mounted concentric to, and driven by, the drive pinion gear stem.

In accordance with this invention, the need for a separate hydraulic motor and pump or drive belts is eliminated thereby reducing the complexity and size of the apparatus while providing increases reliability as compared to alternative designs.

The present invention also provides a unique advantage of utilizing the axle's own lubricant, thus avoiding potential cross-contamination between a specialized hydraulic fluid and the axle lubricant.

### BRIEF DESCRIPTION OF THE DRAWINGS

The present invention will be more apparent from the following description of the preferred embodiments thereof in conjunction with the accompanying drawings in which:

FIG. 1 is a cross-sectional view of a conventional differential apparatus;

FIG. 2 is a cross-sectional view of a differential apparatus in accordance with an embodiment of the present invention; and

FIG. 3 is a cross-sectional view of the primary components of the gerotor hydraulic pump.

### DETAILED DESCRIPTION OF THE PREFERRED EMBODIMENTS

The preferred embodiments of the present invention will now be described in detail with reference to the drawings.

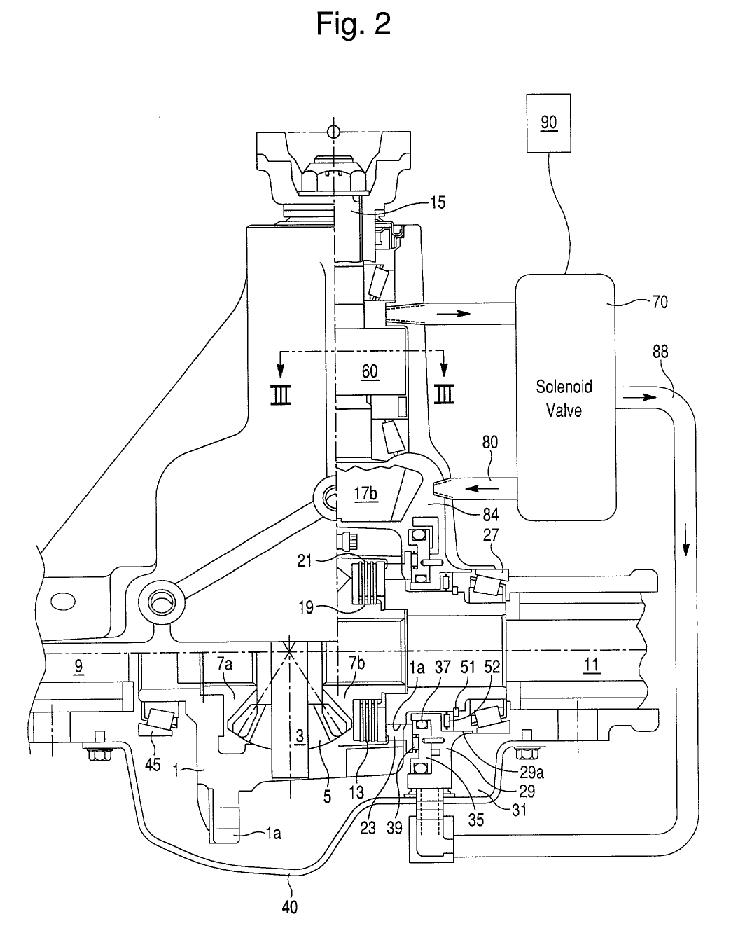

FIG. 2 shows an example of a differential apparatus in accordance with one embodiment of the present invention.

In the example of FIG. 2, a pinion gear 5 is rotatably fitted onto a pinion shaft 3 approximately inserted to a central portion of a differential casing 1. Side gears 7a and 7b are disposed on the right and left hand sides of the pinion gear 5, and are engaged with the pinion gear 5. Output shafts 9 and 11 are fitted into the side gears 7a and 7b, and are respectively connected to left and right wheels, which are not shown. A frictional clutch 13 is disposed between the differential casing 1 and the side gear 7a, and is composed of a plurality of clutch plates as a differential restricting means for restricting the differential by frictional force. A ring gear (not shown) is disposed in a flange portion 1a arranged in the outer circumference of the differential casing 1 on one side of the pinion shaft 3, e.g., on the left hand side thereof. A drive pinion gear 17b is disposed at an end of an input shaft 15, and constitutes a hypoid gear together with the ring gear. Accordingly, an input from the input shaft 15 is transmitted to the differential casing 1, and the differential apparatus is thereby driven.

One set 21 of the frictional plates of the frictional clutch 13 is movable by a thrust force, and is engaged with a spline in the inner circumference of the differential casing 1. The remaining other set 19 of the frictional plates is movable by a thrust force, and is engaged with a spline in the outer circumference of a boss of the side gear 7a. The frictional plates 19, 21 of the clutch 13 are alternately arranged with respect to each other in the axial direction.

A pressure ring or member 23 is movably fitted in the axial direction onto the outer circumferential surface of the differential casing 1, and can move in a direction of increasing frictional force to couple the frictional clutch 13 by pressing and moving the frictional plates 19 and 21 and forcing them to make contact with each other. The pressure ring 23 and the frictional clutch 13 are connected to each other through a push rod or pressure member slidably inserted into a hole 1a formed along the axial direction of an output shaft 11 in the differential casing 1.

The differential casing 1 is rotatably supported at right and left ends thereof by a differential carrier 31 through bearings 45 and 27. An annular oil pressure cylinder 29 as a drive means is disposed between the bearing 27 and the pressure ring 23. A cylindrical portion of the oil pressure cylinder 29 has a projecting portion 29a at the rear end thereof fitted into a bearing hole of the differential carrier 31. A ring-shaped piston 35 opposite the pressure ring 23 is hermetically and slidably inserted into the cylindrical portion of the oil pressure cylinder 29 through a seal member or O-ring 37.

An operating oil is supplied to an operating oil chamber of the oil pressure cylinder 29, and the piston 35 is pressed to the left by the operating oil, and simultaneously the oil pressure cylinder 29 is pressed to the right by a reactionary force. A stopper 51 for preventing the oil pressure cylinder 29 from moving to the right is disposed externally on the differential casing 1 on the right hand side of the oil pressure cylinder 29. A needle bearing 52 and an intermediate member are disposed between the stopper 51 and the oil pressure cylinder 29.

A thrust bearing 39 is disposed between a front end face of the piston 35 and a rear end face of the pressure ring 23, and has a retainer on the inner circumference thereof rotatably engaged with a backward step portion, of the pressure ring 23.

The differential gear mechanism is disposed within the differential carrier 31, and an operating oil supply hole 41 is formed in a portion of the differential carrier 31 and/or a differential cover 40 for maintenance disposed on the lower face side of the differential carrier 31. An operating oil passage is connected to the operating oil chamber 42 of the oil pressure cylinder 29. Accordingly, the operating oil supplied into the operating oil passage is supplied to the operating oil chamber 42, and the piston 35 is slid by the pressure of the operating oil, thereby pressing the pressure ring 23. The pressure ring 23 presses the frictional clutch 13 through the push rod 25 in a direction of increasing frictional force.

The oil pressure cylinder 29, which functions as an actuator for pressing the frictional clutch 13, is adjusted with respect to the supplied amount of the operating oil, and is controlled in operation based on road conditions by a control system constituted by sensors, control circuits, regulators, etc.

In accordance with the preferred embodiment of this invention, operating oil is supplied to the oil operating passage via an oil delivery system including a gerotor pump 60 that is mounted concentric to, and driven by, the drive pinion gear stem 15. Operating oil is pumped from the gerotor pump 60 into a delivery system that includes a valve (e.g., solenoid valve) 70, a return bleed 80 to the sump 84 formed in the carrier 31, and a passage system 88 leading from the valve 70 to the oil operating passage. The solenoid valve 70 is controlled by a control signal delivered from the vehicle control module 90 which functions in accordance with known techniques in the transmission art.

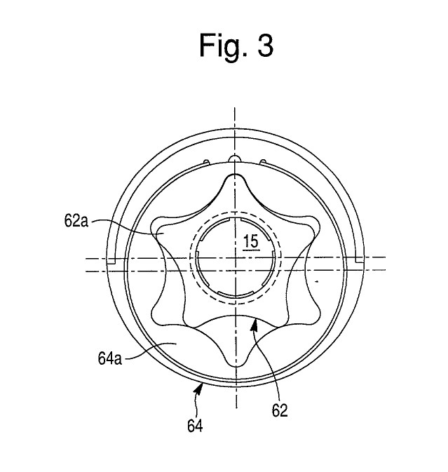

FIG. 3 illustrates the major components of the gerotor pump 60. Internal gear pumps and gerotor pumps are positive displacement fluid pumps the design of which is based on the use of a gear with teeth 62a around the outer perimeter of an inner rotor 62 engaged by the gear teeth 64a around the inner perimeter of a larger ring-shaped rotor 64. The axes of rotation of the two rotors 62, 64 are displaced one from the other by a distance equal to the difference between the pitch radii of the two gears or rotors 62, 64. In addition, the axes of rotation of the two rotors are maintained by the inner rotor being mounted to the drive pinion gear shaft 15 and the outer rotor 64 supported within a cylindrical bore that is rigidly located relative to the center of rotation of the shaft 15 of the inner rotor 62. Such a gerotor pump serves to pump fluid disposed between the respective teeth 62a, 64a; in this instance, operating oil is pumped toward the solenoid valve 70 from the sump area 84 in the carrier 31.

The operation of the differential apparatus mentioned above will be described next.

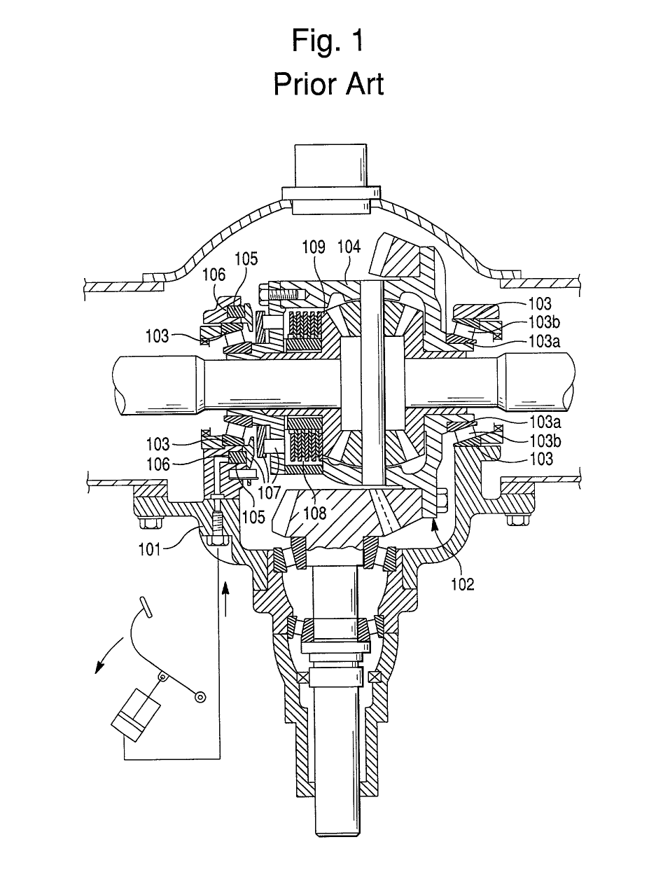

When one of the right or left wheel of a vehicle slips on a slippery surface and a differential is generated therebetween during the operation of the vehicle, the differential rotation of the differential gear mechanism is restricted by the differential restricting means 13. Namely, the operating oil from the gerotor oil pump 60, etc., is supplied to the operating oil chamber from the operating oil passage. The piston 35 presses the pressure ring 23 by the pressure of the operating oil supplied to the operating oil chamber, thereby pressing the frictional clutch 13 through the pressure rod of the pressure ring 23 in the direction of increasing frictional force, i.e., in the left direction in FIG. 1. When the frictional clutch 13 is pressed, the relative rotation of the side gear 7b and the differential casing 1 is restricted in accordance with the increase in the pressing force, thereby restricting the differential of the differential gear mechanism.

As apparent to those of skill in the art, the present invention provides a compact differential transmission apparatus having an improved mechanical strength without greatly changing the design of the differential apparatus.

A major benefit of the present invention resides in a differential transmission apparatus comprising a differential casing rotatably supported by a differential carrier through bearing means, and having a differential mechanism; and means for restricting the differential of the differential mechanism by, for example, frictional force. Preferably, the restricting means is disposed within the differential casing. Moreover, the apparatus comprises means for pressing the restricting means to control the frictional force in the differential mechanism; and drive means for actuating the pressing means, whereby the drive means includes a gerotor hydraulic pump that is mounted concentric to, and driven by, the drive pinion gear stem.

In accordance with this invention, the need for a separate hydraulic motor and pump or drive belts is eliminated thereby reducing the complexity and size of the apparatus while providing increased reliability as compared to alternative designs. The present invention also provides a unique advantage of utilizing the axle's own lubricant, thus avoiding potential cross-contamination between a specialized hydraulic fluid and the axle lubricant.

While the present invention has been shown and described with reference to a preferred embodiment, it will be understood by those of skill in the art that various changes in form and detail may be made therein without departing from the spirit and scope of the claimed invention.

What is claimed is:

1. A power transmission apparatus comprising:
a first carrier member;
a second rotary member rotatably supported by the first carrier member for rotation about an axis, said second rotary member comprising first and second mutually coaxial output shafts which can rotate independently from each other;
frictional engagement members being responsive to an actuating force applied thereto to limit relative rotation between said first and second output shafts; and
a pump system driven by an input shaft that delivers torque to said second rotary member, said pump system delivering hydraulic fluid to said frictional engagement means.

2. The power transmission apparatus of claim 1, wherein said input shaft is a drive pinion gear stem and said pump system comprises a rotor member driven by a drive pinion gear stem.

3. The power transmission apparatus of claim 1, wherein said pump system comprises a gerotor pump that is mounted concentric to, and driven by, a drive pinion gear stem.

4. The power transmission apparatus of claim 2, wherein said pump system is disposed between a pair of bearings rotatably supporting said drive pinion gear stem.

5. The power transmission apparatus of claim 4, wherein said pump system delivers hydraulic fluid in a direction away from a drive pinion driven by said gear stem.

6. The power transmission apparatus of claim 3, wherein said hydraulic fluid is pumped from the gerotor pump into a delivery system that includes a return bleed to a sump formed in the first member.

7. The power transmission apparatus of claim 6, wherein said sump is disposed in an area within said carrier member adjacent a drive pinion driven by said input shaft.

8. The power transmission apparatus of claim 6, wherein said delivery system comprises a control valve and a passage system leading from the control valve to an oil operating passage leading to an actuator actuating said frictional engagement members.

9. The power transmission apparatus of claim 8, wherein said control valve is controlled by a control signal delivered from a vehicle control module.

10. The power transmission apparatus of claim 8, wherein said control valve selectively delivers said hydraulic fluid to at least one of said actuator of said frictional engagement members and said sump.

11. The power transmission apparatus of claim 1, wherein said second rotary member comprises a differential casing rotatably supported on said carrier member through at least one bearing, and carrying a differential mechanism for transmitting power to said first and second output shafts which are adapted to rotate individually, and the frictional engagement members comprises means for restricting the differential of the differential mechanism by a frictional force.

12. The power transmission apparatus of claim 11, wherein said restricting means is disposed within the differential casing, and pressing means press the restricting means to control the frictional force in the differential mechanism.

13. The power transmission apparatus of claim 12, further comprising a stopper arranged on said second rotary member to be engaged by and to provide a reactionary force resisting axial movement of said pressing means in a direction opposite to said one direction during exertion of said actuating force.

14. The power transmission apparatus as claimed in claim 12, wherein the restricting means comprises a frictional clutch coupled and decoupled by the frictional force, and the pressing means comprises a cylinder and a piston disposed in the cylinder.

15. The power transmission apparatus as claimed in claim 12, wherein the pressing means comprises a pressure ring actuated by the piston, and a push rod for connecting the pressure ring to the frictional clutch.
